(19) United States
(12) Patent Application Publication
(10) Pub. No.: US 2017/0352118 A1
(43) Pub. Date: Dec. 7, 2017

(54) SYSTEM AND METHOD FOR PROVIDING CARE RESOURCES TO A SUBJECT

(71) Applicant: KONINKLIJKE PHILIPS N.V., EINDHOVEN (NL)

(72) Inventors: Ana Jorge RODRIGUES DE MOURA LEITAO, Eindhoven (NL); Gijs GELEIJNSE, Geldrop (NL); Jennifer CAFFAREL, Eindhoven (NL); Andre Melon BARROSO, Aachen (DE)

(21) Appl. No.: 15/609,985

(22) Filed: May 31, 2017

Related U.S. Application Data
(60) Provisional application No. 62/343,923, filed on Jun. 1, 2016.

(51) Int. Cl. G06Q 50/22; G06F 19/00; G06Q 50/24

(52) U.S. Cl. CPC G06Q 50/22; G06F 19/363; G06F 19/322; G06F 19/327; G06Q 50/24; G06F 19/3487

(57) ABSTRACT

The present disclosure pertains to a method and system configured for providing care resources to a subject. The system comprises at least one processor; memory and a communication component operatively connected to the at least one processor. The at least one processor is configured to receive information associated with a subject from a user device, determine a category of care to be provided to the subject based on the received information, identify one or more care resources that provide the category of care based on the received information, estimate respective waiting times at the one or more care resources, deliver information associated with the one or more care resources and the respective waiting times to the user device, receiving a selection of the one or more care resources from the user device, and provide instructions to the user device for the subject to arrive at the selected care resource.

### CROSS-REFERENCE TO PRIOR APPLICATIONS

This application claims the benefit of U.S. Provisional Application No. 62/343,923, filed on 2016 Jun. 1. This application is hereby incorporated by reference herein.

### BACKGROUND

### 1. Field

The present disclosure pertains to a system and method for providing care resources to a subject.

### 2. Description of the Related Art

The waiting time and prioritization of care at care resources such as hospitals, clinics, emergency centers are concerns in the healthcare system. In Brazil where all the habitants have access to the public health system known as Sistema Unico de Saude (SUS), hospital emergency rooms (ERs) are overloaded because people prefer to visit the ERs instead of other care facilities. The patients consider the public hospitals and/or ERs as the main access to receive care regardless that the need may not be urgent. In 2014, approximately 50.8% of the patients in Brazil who visited the public hospitals and/or ERs could have solved their problems by visiting a basic unit of care or Unidade Basica de Sande (UBS).

To improve the efficiency of care services and the treatment outcome, triage systems and/or triage applications are implemented in the healthcare system to prioritize patents based on their urgency levels. For subjects with non-urgent complaints, alternative resources such as UBS, primary cares, specialist clinics are recommended. A system called Fast Track is implemented in the hospitals and ERs in Brazil. Fast Track pre-evaluates the subjects' urgency levels after the subjects arrive at the hospitals and/or ERs. Subjects are separated into two waiting queues corresponding to two types of care: basic care and urgent care. Subjects with minor urgency such as a small cut, flu or a broken arm are directed to the waiting queue of basic care; while subjects having severe illness symptoms are directed to the waiting queue of urgent care. Fast Track relieves the burden on the ERs of the hospitals but is less effective in relieving the burden on the basic care units of the hospitals.

A similar pre-triage system is implemented in the Centro Materno Infantil do Norte (Maternity and Child Center of the North) in Porto, Portugal. The pre-triage system collects information about the subject such as personal information and symptoms of illness after the subjects arrive at the center. The pre-triage system categorizes the urgency level based on collected information using data mining techniques. The results are automatically forwarded to an intelligence decision support system (IDSS) to assist the triage of the subjects.

The current triage and/or pre-triage systems assess the subjects' urgency levels after the subjects arrive at the public hospitals and/or ERs. Subjects classified as minor urgencies are still taken care of by the public hospitals. There is little control over when subjects arrive and/or which resource the subjects choose to visit. Therefore, there is a need to provide a pre-assessment of the subjects' urgency levels and/or a pre-triage recommendation on the care resources remotely to the subjects before the subjects visit the public hospitals and/or ERs.

### SUMMARY

Accordingly, one or more aspects of the present disclosure relate to a system for providing care resources to a subject. The system comprises at least one processor; memory operatively connected with the at least one processor; and a communication component operatively connected to the at least one processor. The at least one processor is configured by machine-readable instructions to receive information associated with a subject from a user device, determine a category of care to be provided to the subject based on the received information, identify one or more care resources that provide the category of care based on the received information, estimate respective waiting times at the one or more care resources, deliver information associated with the one or more care resources and the respective waiting times to the user device, receiving a selection of the one or more care resources from the user device, and provide instructions to the user device for the subject to arrive at the selected care resource based on the information associated with the subject and the respective waiting times.

Yet another aspect of the present disclosure relates to a method implemented on a system for providing care resources to a subject. The system comprises at least one processor, memory, and a communication component. The method comprises receiving information associated with a subject from a user device, determining a category of care to be provided to the subject based on the received information, identifying one or more care resources that provide the category of care based on the received information, estimating respective waiting times at the one or more care resources, delivering information associated with the one or more care resources and the respective waiting times to the user device, receiving a selection of the one or more care resources from the user device, and providing instructions to the user device for the subject to arrive at the selected care resource based on the information associated with the subject and the respective waiting times.

Still another aspect of the present disclosure relates to a system for providing care resources to a subject. The system comprises means for receiving information associated with a subject from a user device; means for determining a category of care to be provided to the subject based on the received information; means for identifying one or more care resources that provide the category of care based on the received information; means for estimating respective waiting times at the one or more care resources; means for delivering information associated with the one or more care resources and the respective waiting times to the user device; means for receiving a selection of the one or more care resources from the user device, and means for providing instructions to the user device for the subject to arrive at the selected care resource based on the information associated with the subject and the respective waiting times.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A illustrates an exemplary configuration of a system for providing care resources to a subject, in accordance with an embodiment of the present disclosure;

FIG. 1B illustrates an exemplary configuration of a system for providing care resources to a subject, in accordance with another embodiment of the present disclosure;

FIG. 2 illustrates an exemplary configuration of a care resource triage server for providing care resources to a subject, in accordance with an embodiment of the present disclosure;

FIG. 3 illustrates an exemplary flowchart for providing care resources to a subject, in accordance with an embodiment of the present disclosure; and

FIG. 4 illustrates an exemplary flowchart for providing care resources to a subject, in accordance with another embodiment of the present disclosure.

### DETAILED DESCRIPTION OF EXEMPLARY EMBODIMENTS

In the following detailed description, numerous specific details are set forth by way of examples in order to provide a thorough understanding of the relevant disclosures. However, it should be apparent to those skilled in the art that the present disclosures may be practiced without such details. In other instances, well known methods, procedures, systems, components, and/or circuitry have been described at a relatively high-level, without detail, in order to avoid unnecessarily obscuring aspects of the present disclosures.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure describes a system and method that provides the subject with a pre-assessment of the subject's medical needs and one or more care resource recommendations before the subject visits the care resource. The system combines triage techniques with classification systems to determine the type of care the subject needs. The system further selects one or more care resources that meet the subject needs. The system collects the vital signs and main symptoms related to a subject via one or more user devices and/or peripheral devices. The collected data is further compared with the personal information and medical records of the subject from one or more databases to determine the type of care to be provided to the subject. Based on the results of the pre-assessment and using a global positioning system (GPS) system, the system recommends one or more nearby care resources to the subject. If the subject selects one of the one or more recommended care resources, the system further communicates with the queue management system of the selected care resource and pre-enrolls the subject in the waiting queue before the subject's arrival. The system further tracks the check-in status of the subject and provides the updated waiting time to the user device. Further, the system may notify the care resources connected to the network with the confirmation of the subject's check-in.

According to the present disclosure, subjects with low-level medical urgencies use the UBS resources instead of the public hospitals and/or ERs, and thus the overall waiting time at the public hospitals and/or ERs can be reduced. In addition, subjects with low-level medical urgencies may receive continuous cares from the UBS resources, and therefore improving the outcome of the visits and diminishing the probability of recurrence. The present disclosure also facilitates balancing the workloads of the care resources via predicting and managing the number of subjects visiting the care resources.

The novel features of the present disclosure may be realized and attained by practice or use of various aspects of the methodologies, instrumentalities and combinations set forth in the detailed examples discussed below and the appended claims.

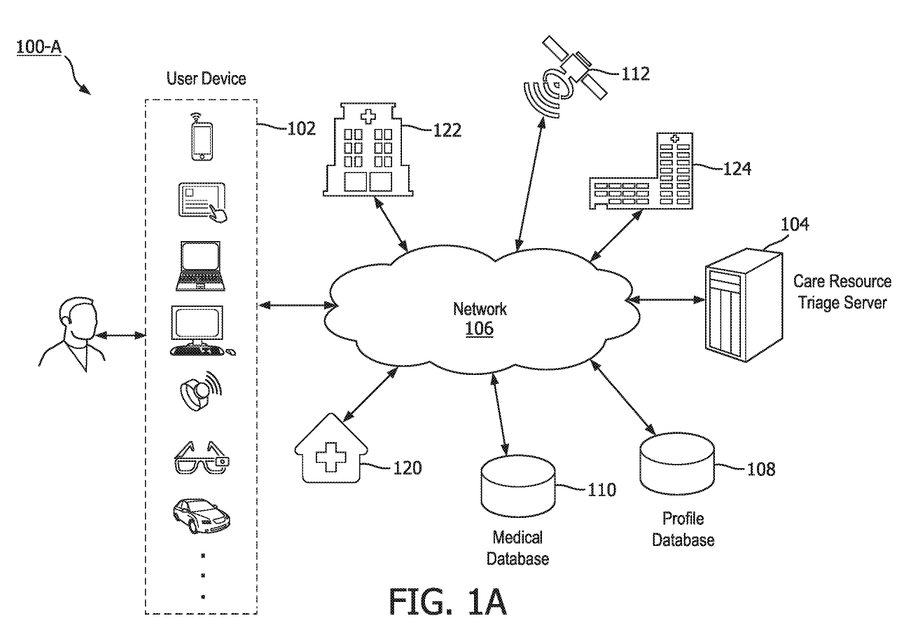

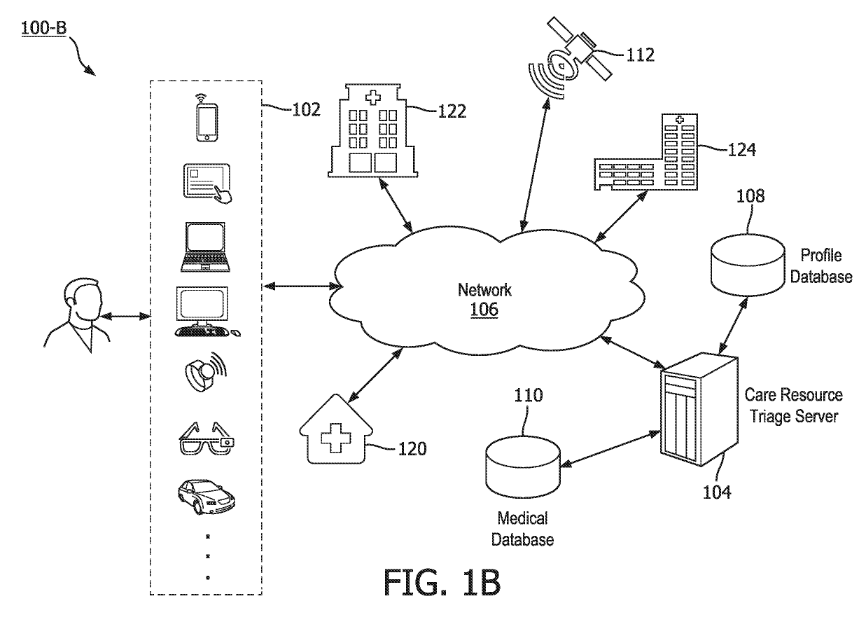

FIG. 1A illustrates an exemplary configuration of a system for providing care resources to a subject, in accordance with an embodiment of the present disclosure. The system comprises one or more user devices 102, a care resource triage server 104, a network 106, a profile database 108, a medical database 110, a global positioning system (GPS) 112, and one or more care resources 120, 122, and 124.

Care resources according to the present disclosure comprise but not limited to hospitals, medical centers, urgent care centers, primary care clinics, specialist clinics, medical exam facilities, etc. Care resources may have fixed geographic locations. In some embodiments, care resources may be mobile care facilities. Care resources connect to network 106 via various access manners such as dial-up access, integrated services digital network (ISDN), leased lines, cable internet access, digital subscriber line (DSL), asymmetric digital subscriber line (ADSL), symmetric digital subscriber line (SDSL), and very-high-bit-rate digital subscriber line (VDSL or VHDSL), DSL rings, fiber-to-the-building (FTTB), broadband over power lines (BPL), asynchronous transfer mode (ATM) and Frame Relay, wireless broadband access, satellite broadband, mobile broadband, worldwide interoperability for microwave access (WiMAX), wireless internet service providers (Wireless ISPs), local multipoint distribution service (LMDS), etc. The examples related to care resources described above are for illustrative purpose. The present disclosure is not intended to be limiting.

User device 102 may include one or more computing devices implemented with a care resource triage application to collect information from a subject and forward the received information to care resource triage server 104 to determine a type of care and a level of urgency. User device 102 further receives information related to one or more candidate care resources from care resource triage server 104 and displays the received information to the subject. Once the subject selects one of the one or more candidate care resources, user device 102 sends the selection to care resource triage server 104 such that the subject is enrolled at the selected care resource. User device 102 may further coordinate the care resource triage program with a GPS program implemented therein to provide instructions for the subject to arrive at the selected care resource. User device 102 includes but not limited to desktop computers, laptop computers, mobile phones, tablets, a built-in device in a motor vehicle, or a wearable device such as wearable watch or heads-up display smart glasses. User device 102 is configured to communicate with care resource triage server 104 via network 106. In some embodiments, user device 102 may be configured to communicate with other devices associated with the same subject such that various devices are synchronized. In some other embodiments, user device 102 may be configured to communicate with profile database 108 to retrieve information related to the subject and/or to save information to the database. The examples of user device 102 described above are for illustrative purpose. The present disclosure is not intended to be limiting. User device 102 may include any other on-body sensor devices, on-clothing sensor devices, etc.

Care resource triage server 104 is configured to be a backend server for managing the available care resources on network 106 and recommending one or more suitable care resources to the subject. Care resource triage server 104 monitors the operating status of the available care resources, for example, care resources 120, 122, and 124. The operating status of a care resource includes but not limited to, operation hours, the number of doctors, nurses, and/or staff on site, waiting times at the queue system for various service units, supplies inventory, etc. Care resource triage server 104 receives real-time and/or periodically updates on the operating status of the available care resources. For example, care resource triage server 104 may receive the operation hours of a care resource once every month because the operation hours are less likely to change frequently. In another example, care resource triage server 104 may receive the dynamic waiting time at a triage unit of an urgent care center every hour and/or upon a manual enrolling/de-enrolling of a subject is performed at the triage unit of the urgent care center.

Care resource triage server 104 receives a request from a subject for recommendations on the care resources based on information associated with the subject. The information received at care resource triage server 104 includes but not limited to personal data of the subject, illness description by the subject, main needs of the subject, location of the subject, time availability of the subject, and/or transportation availability of the subject. Personal data of the subject may be manually inputted by the subject via user device 102. If the subject's profile already exists, the personal data may be automatically retrieved from the local memory of user device 102, and/or downloaded from profile database 108 via network 106.

Illness description may include one or more measurements of the subject's vital signs and a description of the illness by the subject. In some embodiments, illness description comprises pain level scales, symptom lists and the collection of the vital signs. The collection of the vital signs may be automatically performed by peripheral devices and/or applications implemented on the user devices such as a stethoscope, a blood pressure meter, a blood glucose meter, a thermometer, an eye testing accessory or application, etc. The one or more measurements of the subject's vital signs and the description of the illness may be inputted by the subject via an interface of user device 102 such as a keyboard, a mouse, a touch screen, a microphone, a voice recognition application, etc. In some embodiments, the peripheral device may be configured to be capable of connecting to user device 102, and thus, the measurements are automatically acquired via the care resource triage application implemented on the user device.

In some embodiments, user device 120 may be implemented with one or more GPS applications that enable user device 120 to communication with GPS 112. Via the implemented one or more GPS applications on the user device, care resource triage server 104 determines the location of the subject. Care resource triage server 104 recommends the care resources based on the distance between the location of the subject and the care resources. In some embodiments, care resource triage server 104 receives the time availability inputted by the subject and/or retrieves the time availability via the calendar implemented on the user device. In some other embodiments, care resource triage server 104 receives the transportation availability inputted by the subject, for example, whether the subject has a car to drive to the care resource. The above examples are for illustrative purpose. The present disclosure is not intended to be limiting. The transportation availability may include whether the subject can walk to the care resource, bike to the care resource, motorcycling to the care resource, take one or more buses and/or trains to the care resources, take one or more flights to travel to the care resources, and/or any combinations of the transportations described above. In some embodiments, the transportation availability may include the availability of using any types of personal transportation tools such as a self-balancing and battery-powered electric vehicle (single wheel and/or multiple wheels), a scooter, a skateboard, etc.

Care resource triage server 104 is further configured to categorize the care to be provided to the subject based on the received information. Care resource triage server 104 determines one or more types of care to be provided to the subject and evaluates a level of urgency. Care resource triage server 104 further identifies one or more care resources that can meet the subject's needs based on the operating status of the available care resources, and delivers the one or more care resources as recommendations to the user device.

In some embodiments, care resources have attributes identifying which complaints they can handle. Cough for example, can be handled by a primary care doctor, a 24 hour clinic, or a pulmonologist. The symptom lists may be pre-generated by a user based on projected and desired medical services and further updated to make the symptom lists context-specific. The population of attributes can be performed by analyzing the past visit details, using presenting symptoms and diagnostic codes, and evaluating qualifications and experience of the staff in the care resource.

Given the patent's pre-assessment, the symptom list is filtered to provide the relevance services to handle the presenting complaints. From the symptom list, a care resource is selected and assigned to the subject by combining a plurality of aspects including but not limited to: current and projected waiting times and available slots at these care resources with “0” indicating overcrowded and “1” indicating lots of availability; an assessment of the reachability of the care resources with “0” indicating unreachable and “1” indicating “easily reachable;” estimated cost level with respect to each care resource with “0” indicating most expensive and “1” indicating least expensive; and an assessment of familiarity of the care givers associated with the care resources with “0” indicating never seen before and “1” indicating regular visiting. Care resource triage server 104 determines a match between the care resources and/or care providers and the subject by calculating the maximum of all weighted sum of these four aspects. In some embodiments, the weights for the above noted aspects are pre-determined based on the specific needs of a health care organization.

In some embodiments, care resource triage server 104 receives a user selection of one of the one or more care resources. In response to the user selection, care resource triage server 104 provides instructions to the user device for the subject to travel to the selected care resource based on the subject's transportation availability. The instructions may include one or more travel options such as via car, bus, subway, walk, and/or any combination thereof. The instructions may further include arrival times with respect to the one or more travel options estimated based on the location of the subject, location of the selected care resource, and the time availability of the subject. In some embodiments, the instructions may further include a recommendation of the one or more travel options determined based on the transportation availability of the subject. In some embodiments, the instructions may be presented in textual information. In another embodiment, the instruction may be an active phone call to the emergency line while supporting the subject by allowing him/her to send partial collected data. In some embodiments, care resource triage server 104 may simultaneously forward the subject information to the selected care resource so that the subject is enrolled in the queue system of the selected care resource prior to the arrival of the subject. A unique identifier associated with the queue system of the selected care resource may be shared with the subject. In some embodiments, when the subject selects one of the one or more travel options, the selection is simultaneously forwarded to care resource triage server 104 and the estimated arrival time associated with the selected travel option is inputted into the queue system of the selected care resource. By enrolling the subject in the selected care resource prior to the arrival, not only the selected care resource is notified with the subject's arrival, but also the estimated arrival time of the subject. As such, the present disclosure facilitates the individual care resource connected to the network to manage the queue system as well as to predict the workload.

In some embodiments, the selected care resource receives additional information such as the time of arrival, subject details (e.g., conditions/symptoms/type of subject), and real-time vital signs collection while the subject is enrolled to a queue for triage in the selected care resource. When the subject is determined to need urgent care, the additional information allows the preparation of a team to receive the subject, thus improving the overall outcome of the given care. In some embodiments, the subject may be enrolled to more than one queue in the selected care resource. For example, when the subject is determined to need urgent care that requires an appointment, the subject is enrolled in two different queues. In some embodiments, while sharing the additional information with the selected care resource, the subject may communicate with the care team and agrees on a suitable time to arrive. Depending on the pre-assessment, the suitable time may be a time slot on the same day or a few days later.

In some embodiments, the queue system follows first in/first out policy, such as “The subject needs a preventive flu vaccine.” In another embodiment, the subject may retrieve the current waiting time and the number of people in the queue of the selected care resource prior to departure. Matching such information with the GPS data and means of transportation, care resource server 104 predicts when the subject would be receiving the care and/or when would be the best time to go to the selected care resource.

Care resource server 104 may be further configured to track the check-in status of the subject using the unique identifier and update the waiting time at the pre-selected care resource. In some embodiments when the subject checks in at the selected care resource, care resource server 104 receives the check-in confirmation from the selected care resource via the network. Care resource server 104 further estimates the waiting time for the subject based on the check-in confirmations up to time, and delivers the estimated waiting time to the user device. In some other embodiments when the subject changes his/her mind and checks in at an unselected care resource instead, care resource server 104 estimates the waiting time at the unselected care resource, and delivers the estimated waiting time to the user device. Care resource server 104 estimates the waiting time based on one or more factors including but not limited to the subject's place in the queue, the number of people in the queue and the average waiting time etc. Care resource server 104 may further communicate with the previously selected care resource to remove the enrollment of the subject from the queue system therein.

The configurations of care resource server 104 described above are for illustrative purpose. The present disclosure is not intended to be limiting. Care resource server 104 may be a general computing server or a dedicated computing server. Care resource server 104 may be configured to provide backend support for any care resource management system. Therefore, care resource server 104 may also be configured to be interoperable across other care resource management servers.

Profile database 108 is configured to store the profile data of the subjects including but not limited to personal information of the large population of subjects, records of previous use of the care resource triage application of the large population of subjects, etc. Profile database 108 may be network storage and/or cloud storage directly connected to network 106. In some embodiments however, profile database 108 may be a backend database of care resource server 104, as illustrated in FIG. 1B. In other embodiments, profile database 108 may serve as backend storage of care resource server 104 as well as network storage and/or cloud storage. Profile database 108 is updated periodically and/or in response to a request from user device 102 and/or care resource server 104.

Medical database 110 is configured to store the information and rules related to medical diagnosis. For example, high blood sugar levels over a prolonged period with symptoms of frequent urination, increased thirst, and increased hunger indicate diabetes. Information and rules stored in medical database 110 are accumulated knowledge in the medical field, and are dynamically updated in accordance with the advance of the modern medicine. Medical database 110 serves as a reference to care resource triage server to categorize the care to be provided to the subject.

Network 106 is configured to transmit information among a plurality of components connected to the network. For example, network 106 transmits data collected at user device 102 to care resource triage server 104, and the recommendations of the care resource from care triage server 104 to user device 102. Network 106 may be a single network or a combination of multiple networks. For example, network 106 may be a local area network (LAN), a wide area network (WAN), a public network, a private network, a proprietary network, a Public Telephone Switched Network (PSTN), the Internet, a wireless communication network, a virtual network, and/or any combination thereof.

FIG. 1B illustrates an exemplary configuration of a system for providing care resources to a subject, in accordance with another embodiment of the present disclosure. The configuration of the system for providing care resources to a subject in this embodiment is similar to the system configuration in FIG. 1A, except that profile database 108 and medical database 110 are backend databases connect to care resource triage server 104.

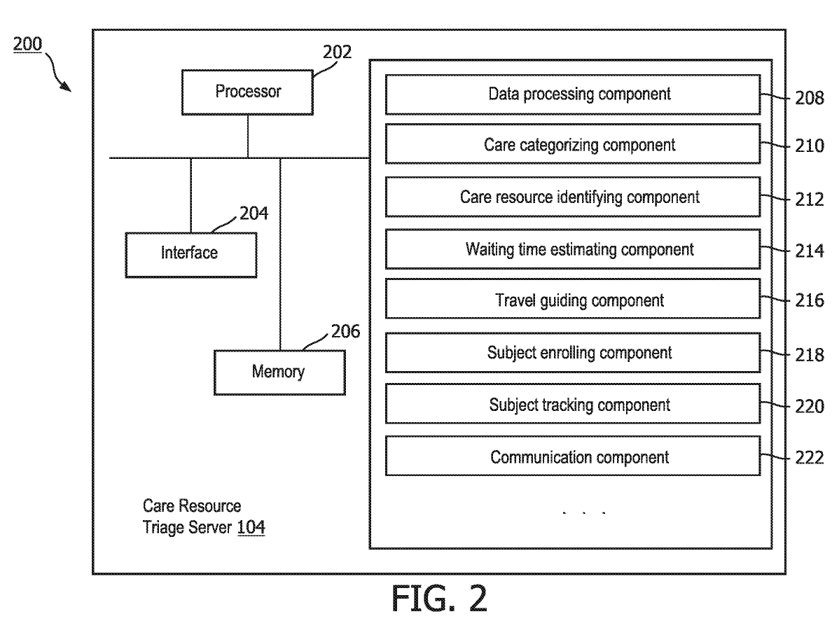

FIG. 2 illustrates an exemplary configuration of a care resource triage server for providing care resources to a subject, in accordance with an embodiment of the present disclosure. Care resource triage server 104 illustrated in FIG. 1 comprises at least one processor 202, an interface 204, memory 206, a data processing component 208, a care categorizing component 210, a care resource identifying component 212, a waiting time estimating component 214, a travel guiding component 216, a subject enrolling component 218, a subject tracking component 220, and a communication component 222.

Processor 202 is operatively communicated with interface 204 and memory 206. Processor 202 may include one or more of a digital processor(s), analog processor(s), a digital circuit designed to process information, an analog circuit designed to process information, a state machine, a transmitter, a receiver, and/or other mechanism(s) or processor(s) for electronically processing information. Although processor 202 is shown in FIG. 2 as a single entity, this is for illustrative purposes only. In some embodiments, processor 202 may include one or more processing units. The one or more processing units may be physically located within a same device. Further, processor 202 may be configured to execute one or more computer program components including data processing component 208, care categorizing component 210, care resource identifying component 212, waiting time estimating component 214, travel guiding component 216, subject enrolling component 218, subject tracking component 220, and communication component 222. Processor 202 may be configured to execute components 208, 210, 212, 214, 216, 218, 220 and 222 by software; hardware; firmware; some combination of software, hardware, and/or firmware; and/or other mechanisms for configuring processing capabilities on processor 202.

Each of the one or more computer programmed components comprises a set of algorithms implemented on processor 202 that instructs processor 202 to perform one or more functions related to generating the statements, and/or other operations. For example, data processing component 208 comprises algorithms implemented on processor 202 that instruct processor 202 to process the received data at interface 204; care categorizing component 210 comprises algorithms implemented on processor 202 that instruct processor 202 to classify the type of care to be provided to the subject; care resource identifying component 212 comprises algorithms implemented on processor 202 that instruct processor 202 to identify one or more care resources to recommend to the subject; waiting time estimating component 214 comprises algorithms implemented on processor 202 that instruct processor 202 to estimate the waiting time at the care resources; travel guiding component 216 comprises algorithms implemented on processor 202 that instruct processor 202 to provide instructions to the subject to arrive at a selected care resource based on the information associated with the subject and the respective waiting time; subject enrolling component 218 comprises algorithms implemented on processor 202 that instruct processor 202 to enroll the subject at the selected care resource; subject tracking component 220 comprises algorithms implemented on processor 202 that instruct processor 202 to track the check-in status of the subject; and communication component 222 comprises algorithms implemented on processor 202 that instruct processor 202 to perform communications within one or more components of processor 202, and between processor 202 and other components of the system and/or other network components.

It should be appreciated that although components 208, 210, 212, 214, 216, 218, 220 and 222 are illustrated in FIG. 2 as being co-located with a single processing unit, in implementations in which processor 202 includes multiple processing units, one or more of these components may be located remotely from the other components. The description of the functions provided by the different components 208, 210, 212, 214, 216, 218, 220 and 222 described below is for illustrative purposes, and is not intended to be limiting, as any of components 208, 210, 212, 214, 216, 218, 220 and 222 may provide more or less functions than is described. For example, one or more of components 208, 210, 212, 214, 216, 218, 220 and 222 may be eliminated, and some or all of its functions may be provided by other ones of components 208, 210, 212, 214, 216, 218, 220 and 222. As another example, processor 202 may be configured to execute one or more additional components that may perform some or all of the functions attributed below to one of components 208, 210, 212, 214, 216, 218, 220 and 222.

Interface 204 is configured to provide an interface between care resource triage server 104 and user device 102. Data transmitted via network 106 is received at interface 204 and further forwarded to data processing component 208. In some embodiments, interface 204 may be a computer programmed component implemented on care resource triage server 104 and configured to automatically monitor incoming data from network 106. In some other embodiments, interface 204 may further include one or more exterior devices such as, a keypad, buttons, switches, a keyboard, knobs, levers, a display screen, a touch screen, speakers, a microphone, a printer, and/or other interface devices. In some embodiments, interface 204 may include a plurality of separate interfaces, and/or a combination of the interfaces set forth above.

Memory 206 is configured to electronically store information in an electronic storage media. Memory 206 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. The electronic storage media of memory 206 may comprise one or both of system storage that is provided integrally (i.e., substantially non-removable) with the system and/or removable storage that is removably connectable to the system via, for example, a port (e.g., a USB port, a firewire port, etc.) or a drive (e.g., a disk drive, etc.). Memory 206 stores computer programs to be executed via a plurality of components 208, 210, 212, 214, 216, 218, 220 and 222. In some embodiments, memory 206 stores profile data of the subject received from user device 102 and pre-assessment data generated by care resource triage server 104, which is further uploaded to profile database 108 and medical database 110, respectively.

Data processing component 208 is configured to process the data received via interface 204 and determine which operation to perform based on the received data. For example, if the received data comprises a request for care resource recommendation from a user, data processing component 208 forwards the request to care categorizing component 210. In another example, if the received data comprises a selection of one of the recommended care resources, data processing component 208 forwards the selection to travel guiding component 216. In some embodiments, data processing component 208 may prioritize the operations that need to be performed in accordance with the received data.

Care categorizing component 210 is configured to classify the type of care to be provided to the subject based on the information received from the user device. For example, care categorizing component 210 determines that the subject condition is urgent and the subject is recommended to visit an emergency care unit. In yet another example, care categorizing component 210 determines that the subject condition is not urgent and the subject is recommended to visit a primary care's office. Care categorizing component 210 determines the type of care to be provided to the subject and a level of urgency based on a plurality of factors including but not limited to subject age, medical/allergy history of the subject, illness description, measurements of one or more vital signs, main needs of the subject, etc. In some embodiments, care categorizing component 210 compares the received information with existing records stored in medical database 110 to categorize the type of care. The categorization of the type of care may use data mining techniques to determine a specific urgency level and the type of care that is most adequate (e.g., ER, ambulatory, UBS, dentist, cardiologist, etc.) based on the subject's information.

Care resource identifying component 212 is configured to identify one or more care resources on network that can provide the categorized service to the subject. In some embodiments, care resource identifying component 212 may identify one or more care resources that accept the subject's health insurance plan. In another embodiment, care resource identifying component 212 may identify one or more care resources based on the availabilities of the subject and the care resources. In another embodiment, care resource identifying component 212 may identify one or more care resources based on the locations of the care resources. In another embodiment, care resource identifying component 212 may identify one or more care resources based on the specialties of the care resources. In another embodiment, care resource identifying component 212 may identify one or more care resources based on the transportation availabilities of the subject. In another embodiment, care resource identifying component 212 may identify one or more care resources based on the current waiting time at the care resources. It should be appreciated that the above examples on identifying one or more care resources are for illustrative purpose. The present disclosure is not intended to be limiting. Care resource identifying component 212 may identify one or more care resources based on one or more combinations of the examples described above.

Waiting time estimating component 214 is configured to estimate the waiting time at each of the identified care resources. In some embodiments, waiting time estimating component 214 estimates the waiting time of a care resource based on the last updated waiting time at the queue system of a care resource. Waiting time estimating component 214 may use an average waiting time at the queue system of the care resource during the day, the week, and/or the month. In some embodiments, waiting time estimating component 214 may evaluate additional factors such as the number of the doctors and/or nurses on site, etc. It should be appreciated that the above examples on estimating the waiting time at the care resources are for illustrative purpose. The present disclosure is not intended to be limiting. Waiting time estimating component 214 may estimate the waiting time based on one or more combinations of the examples described above.

Information associated with the identified one or more care resources and the estimated waiting times at the respective care resources are delivered to the user device and presented in order on the user device. In some embodiments, the one or more care resources are ordered based on the distance between the location of the subject and the care resource, where the nearest care resource is presented first. In another embodiment, the one or more care resources are ordered based on the waiting times at the care resources, where the care resource with the shortest waiting time is presented first. In another embodiment, the one or more care resources are ordered based on the capabilities of the care resources. For example, a general hospital with an emergency unit may be presented first. In another embodiment, the one or more care resources are ordered based on the appointment availabilities of the care resources. For example, the care resource more available to take appointments within twenty four hours is presented first. It should be appreciated that the above examples on presenting the identified one or more care resources are for illustrative purpose. The present disclosure is not intended to be limiting. The one or more care resources may be presented to the user based on one or more combinations of the examples described above.

Travel guiding component 216 is configured to provide instructions to the subject to arrive at a selected care resource based on the information associated with the subject and the respective waiting time. While being presented with one or more recommended care resources, the user may select one care resource to acquire the care. The selection of one recommended care resource is received at care resource triage server 104 via the network. Travel guiding component 216 may provide one or more travel options to arrive at the selected care resource with arrival times based on the location of the subject, location of the selected care resource and the time availability of the subject. Travel guiding component 216 may further provide a recommendation of the one or more travel options determined based on the transportation availability of the subject. The transportation availability includes but not limited to whether the subject owns a car, whether the subject's condition allows him/her to drive alone to the care resource, whether the subject has a driver's license, any bus stops and/or metro stations accessible to the subject's location, whether the subject can take one or more flights to arrival at the care resource's city, etc. Travel guiding component 216 provides at least one travel option by combining one or more transportation means described above.

Subject enrolling component 218 is configured to enroll the subject at the selected care resource once a selection is received at the care resource triage server. Subject enrolling component 218 transmits the information associated with the subject to the selected care resource via the network to enroll the subject at the queue system of the care resource. In some embodiments, upon receiving a selection of one of the one or more travel options, subject enrolling component 218 transmits the estimated arrival time associated with the selected travel option to be inputted into the queue system. Enrolling of the subject with the estimated arrival time may secure a bandwidth to provide service to the subject and facilitate the management of the queue system at the care resource.

Subject tracking component 220 is configured to track the check-in status of the subject. As the subject may change his/her mind on the way to the selected care resource, the actual check-in status of the subject varies. The subject may follow the instructions to arrive at the selected care resource and check in the selected care resource. In another example, the subject may check-in at a care resource which is different from the selected care resource but is on the network associated with care resource triage server 104. In another example, the subject may check-in at a care resource which is not on the network associated with care resource triage server 104. Subject tracking component 220 cooperates with each of the care resources on the network associated with care resource triage server 104 and detects the check-in status of the subject dynamically. Once the subject checks in at any of the care resources on the network, care resource triage server 104 receives a confirmation signal about the subject's actual check-in status transmitted via the network.

In some embodiments, subject tracking component 220 is configured to cooperate with waiting time estimating component 214 to re-estimate the waiting time after the subject confirms check-in at the selected care resource. The re-estimated waiting time is delivered to the user device via the network to update the subject.

In another embodiment, subject tracking component 220 is configured to cooperate with subject enrolling component 218 to update the enrollment of the subject. For example, if it is determined that the subject checks in a care resource different from the selected care resource yet on the network associated with care resource triage server 104, subject tracking component 220 transmits the check-in confirmation to subject enrolling component 218. Upon receiving the confirmation, subject tracking component 220 removes the enrollment of the subject from the selected care resource. In another example, the subject checks in at a care resource not on the network associated with care resource triage server 104, or the subject changes his/her mind and decides not to visit any care resources, the check-in status of the subject becomes unavailable to care resource triage server 104. In such circumstances, subject enrolling component 218 may be notified by subject tracking component 220 that the check-in status of the subject is unavailable for a certain period of time, and subject tracking component 220 removes the enrollment of the subject from the selected care resource.

Communication component 222 is configured to perform communications between processor 202 and other components of care resource triage server 104. In some embodiments, communication component 222 communicates with user device 102 to acquire the information related to the subject, and to transmit the recommend one or more care resources to the user device. In some embodiments, communication component 222 communicates with user device 102 to update the application implemented therein. In another embodiment, communication component 222 communicates with profile database 108 to obtain personal information of the subject and records of previous use of the care resource triage system. When a new subject signs in the care resource triage system, communication component 222 further updates profile database 108 with the information related to the new subject. In yet another embodiment, communication component 222 communicates with medical database 110 to obtain the information and rules for the pre-assessment of the subject's condition. Communication component 222 is a physical component implemented on the computer, for example, a network interface controller (also known as a network interface card, network adapter, network interface, etc.). Communication component 222 may be a special expansion card plugged into a computer bus and operatively connected to processor 202. In some embodiment, communication component 222 implements an electronic circuitry required to communicate with the network using a specific physical layer and data link layer standard such as Ethernet, Fiber Channel, Wi-Fi or Token Ring. This provides a base for a full network protocol stack, allowing communication among small groups of computers on the same local area network (LAN) and large-scale network communications through routable protocols, such as Internet Protocol (IP). Communication component 222 may be both a physical layer and data link layer device because it provides physical access to a networking medium and a low-level addressing system for IEEE 802 and similar networks through the use of media access control (MAC) addresses that are uniquely assigned to network interfaces. The present disclosure contemplates any techniques for communication including but not limited to hard-wired and wireless communications.

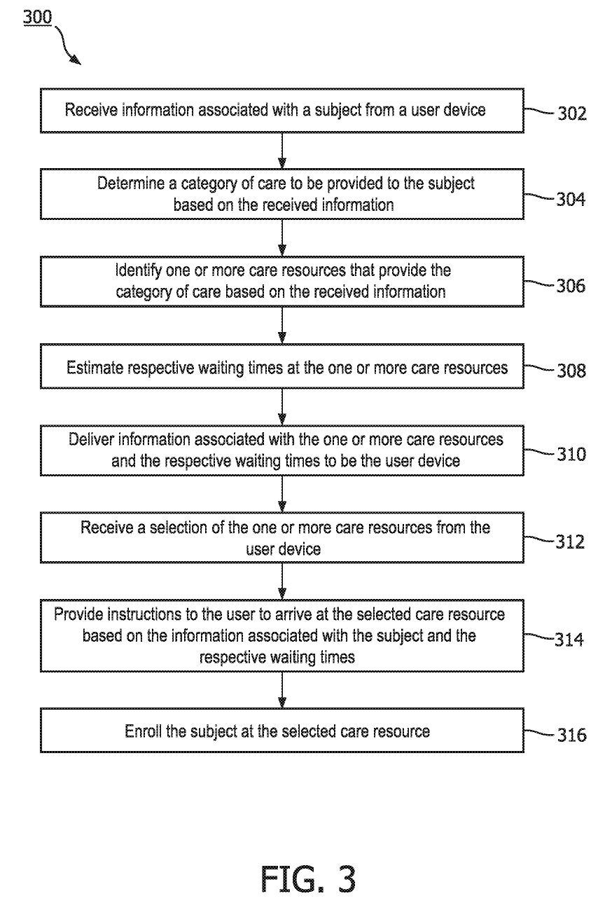

FIG. 3 illustrates an exemplary flowchart for providing care resources to a subject, in accordance with an embodiment of the present disclosure. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 3 and described below is not intended to be limiting.

At operation 302, information associated with a subject is received from a user device. In some embodiments, operation 302 is performed by an interface and/or data processing component the same as or similar to interface 204 and/or data processing component 208 (shown in FIG. 2 and described herein).

At operation 304, a category of care is determined to be provided to the subject based on the received information. In some embodiments, operation 304 is performed by a care categorizing component the same as or similar to care categorizing component 210 (shown in FIG. 2 and described herein).

At operation 306, one or more care resources are identified that provide the category of care based on the received information. In some embodiments, operation 306 is performed by a care resource identifying component the same as or similar to care resource identifying component 212 (shown in FIG. 2 and described herein).

At operation 308, respective waiting times at the one or more care resources are estimated. In some embodiments, operation 308 is performed by a waiting time estimating component the same as or similar to waiting time estimating component 214 (shown in FIG. 2 and described herein).

At operation 310, information associated with the one or more care resources and the respective waiting times are delivered to the user device. In some embodiments, operation 310 is performed by a communication component the same as or similar to communication component 222 (shown in FIG. 2 and described herein).

At operation 312, a selection of the one or more care resources is received from the user device. In some embodiments, operation 312 is performed by a communication component the same as or similar to communication component 222 (shown in FIG. 2 and described herein).

At operation 314, instructions are provided to the user to arrive at the selected care resource based on the information associated with the subject and the respective waiting times. In some embodiments, operation 314 is performed by a travel guiding component the same as or similar to travel guiding component 216 (shown in FIG. 2 and described herein).

At operation 316, the subject is enrolled at the selected care resource. In some embodiments, operation 316 is performed by a subject enrolling component the same as or similar to subject enrolling component 218 (shown in FIG. 2 and described herein).

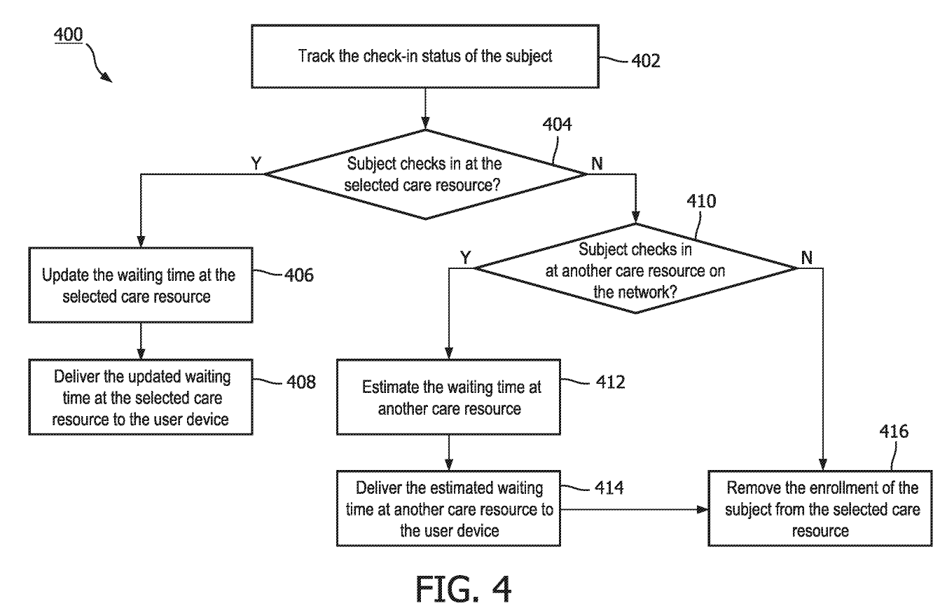

FIG. 4 illustrates an exemplary flowchart for providing care resources to a subject, in accordance with another embodiment of the present disclosure. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 4 and described below is not intended to be limiting.

At operation 402, the check-in status of the subject is tracked. In some embodiments, operation 402 is performed by a subject tracking component the same as or similar to subject tracking component 220 (shown in FIG. 2 and described herein).

At operation 404, a determination is made as to whether the subject checks in at the selected care resource. In some embodiments, operation 404 is performed by a subject tracking component the same as or similar to subject tracking component 220 (shown in FIG. 2 and described herein).

At operation 406, if the subject checks in at the selected care resource, the waiting time at the selected care resource is updated. In some embodiments, operation 406 is performed by a waiting time estimating component the same as or similar to waiting time estimating component 214 (shown in FIG. 2 and described herein).

At operation 408, the updated waiting time at the selected care resource is delivered to the user device. In some embodiments, operation 408 is performed by a communication component the same as or similar to communication component 222 (shown in FIG. 2 and described herein).

At operation 410, a determination is made as to whether the subject checks in at another care resource on the network. In some embodiments, operation 410 is performed by a subject tracking component the same as or similar to subject tracking component 220 (shown in FIG. 2 and described herein).

At operation 412, the waiting time at another care resource is estimated. In some embodiments, operation 412 is performed by a waiting time estimating component the same as or similar to waiting time estimating component 412 (shown in FIG. 2 and described herein).

At operation 414, the estimated waiting time at another care resource is delivered to the user device. In some embodiments, operation 306 is performed by a communication component the same as or similar to communication component 222 (shown in FIG. 2 and described herein).

At operation 416, the enrollment of the subject is removed from the selected care resource. In some embodiments, operation 416 is performed by a subject enrolling component the same as or similar to subject enrolling component 218 (shown in FIG. 2 and described herein).

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system for providing care resources to a subject, the system comprising:
at least one processor;
memory operatively connected with the at least one processor; and
a communication component operatively connected to the at least one processor;
wherein the at least one processor is configure by machine-readable instructions to:
receive information associated with a subject from a user device;
determine a category of care to be provided to the subject based on the information associated with the subject;
identify one or more care resources that provide the category of care based on the received information;
estimate respective waiting times at the one or more care resources;
deliver information associated with the one or more care resources and the respective waiting times to the user device;
receive a selection of the one or more care resources from the user device; and
provide instructions to the user device for the subject to arrive at the selected care resource based on the information associated with the subject and the respective waiting times.

2. The system of claim 1, wherein the at least one processor is further configured by machine-readable instructions to enroll the subject at the selected care resource.

3. The system of claim 1, wherein the at least one processor is further configured by machine-readable instructions to:
receive check-in information of the subject at the selected care resource;
update the waiting time at the selected care resource; and
deliver the updated waiting time at the selected care resource to the user device.

4. The system of claim 1, wherein the at least one processor is further configured by machine-readable instructions to:
receive check-in information of the subject at an unselected care resource;
estimate the waiting time at the unselected care resource; and
deliver the estimated waiting time at the unselected care resource to the user device.

5. The system of claim 1, wherein the category of care to be provided to the subject comprises one or more types of care and a level of urgency evaluated based on the information associated with the subject.

6. The system of claim 1, wherein the information associated with the subject comprises at least one of:
personal data of the subject;
illness description by the subject;
main needs of the subject;
location of the subject;
time availability of the subject; or
transportation availability of the subject.

7. The system of claim 6, wherein the instructions include:
one or more travel options with respective arrival times estimated based on the location of the subject, location of the selected care resource and the time availability of the subject; and
a recommendation of the one or more travel options determined based on the transportation availability of the subject.

8. A method implemented on a system for providing care resources to a subject, the system comprising at least one processor, memory, and a communication component, the method comprising:
receiving information associated with a subject from a user device;
determining a category of care to be provided to the subject based on the received information;
identifying one or more care resources that provide the category of care based on the received information;
estimating respective waiting times at the one or more care resources;
delivering information associated with the one or more care resources and the respective waiting times to the user device;
receiving a selection of the one or more care resources from the user device; and
providing instructions to the user device for the subject to arrive at the selected care resource based on the information associated with the subject and the respective waiting times.

9. The method of claim 8, further comprising:
enrolling the subject at the selected care resource.

10. The method of claim 8, further comprising:
receiving check-in information of the subject at the selected care resource;
updating the waiting time at the selected care resource; and
delivering the updated waiting time at the selected care resource to the user device.

11. The method of claim 8, further comprising:
receiving check-in information of the subject at an unselected care resource;
estimating the waiting time at the unselected care resource; and
delivering the estimated waiting time at the unselected care resource to the user device.

12. The method of claim 8, wherein the category of care to be provided to the subject comprises one or more types of care and a level of urgency evaluated based on the received information.

13. The method of claim 8, wherein the information associated with the subject comprises at least one of:
personal data of the subject;
illness description by the subject;
main needs of the subject;
location of the subject;
time availability of the subject; or
transportation availability of the subject.

14. The method of claim 13, wherein the instructions include:
one or more travel options with respective arrival times estimated based on the location of the subject, location of the selected care resource and the time availability of the subject; and
a recommendation of the one or more travel options determined based on the transportation availability of the subject.

15. A system for generating one or more statements, the system comprising:
means for receiving information associated with a subject from a user device;
means for determining a category of care to be provided to the subject based on the received information;
means for identifying one or more care resources that provide the category of care based on the received information;
means for estimating respective waiting times at the one or more care resources;
means for delivering information associated with the one or more care resources and the respective waiting times to the user device;
means for receiving a selection of the one or more care resources from the user device; and
means for providing instructions to the user device for the subject to arrive at the selected care resource based on the information associated with the subject and the respective waiting time.

16. The system of claim 15, further comprising:
means for enrolling the subject at the selected care resource.

17. The system of claim 15, further comprising:
means for receiving check-in information of the subject at the selected care resource;
means for updating the waiting time at the selected care resource; and
means for delivering the updated waiting time at the selected care resource to the user device.

18. The system of claim 15, further comprising:
means for receiving check-in information of the subject at an unselected care resource;
means for estimating the waiting time at the unselected care resource; and
means for delivering the estimated waiting time at the unselected care resource to the user device.

19. The system of claim 15, wherein the received information associated with the subject comprises at least one of:
personal data of the subject;
illness description by the subject;
main needs of the subject;
location of the subject;
time availability of the subject; or
transportation availability of the subject.

20. The system of claim 15, wherein the instructions include:
one or more travel options with respective arrival times estimated based on the location of the subject, location of the selected care resource and the time availability of the subject; and
a recommendation of the one or more travel options determined based on the transportation availability of the subject.
